(19) United States
(12) Patent Application Publication
(10) Pub. No.: US 2011/0242718 A1
(43) Pub. Date: Oct. 6, 2011

(54) PROTECTION CIRCUIT FOR CENTRAL PROCESSING UNIT

(75) Inventor: Pei-Hua Sun, Taipei (TW)

(73) Assignee: ASUSTEK COMPUTER INC., Taipei City (TW)

(21) Appl. No.: 13/074,020

(22) Filed: Mar. 29, 2011

(30) Foreign Application Priority Data
Mar. 31, 2010 (TW) 99109864

(51) Int. Cl. H02H 3/24

(52) U.S. Cl. 361/92

(57) ABSTRACT

A protection circuit for a central processing unit (CPU) is provided. The protection circuit has a detecting unit and an enable switch. The detecting unit detects whether the short is occurred or not between a power pin of the CPU and the ground end before providing a system voltage to the CPU. The enable switch is coupled to the detecting unit. The enable switch determines whether to provide the system voltage to the power pin of the CPU according to the detecting result of the detecting unit. When the short is occurred between the power pin of the CPU and the ground end, the enable switch turning off for cutting off the system voltage from being provided to the CPU and prevents an electronic device including the CPU from booting.

### CROSS-REFERENCE TO RELATED APPLICATION

This application claims the priority benefit of Taiwan application serial no. 99109864, filed Mar. 31, 2010. The entirety of the above-mentioned patent application is hereby incorporated by reference herein and made a part of this specification.

### BACKGROUND OF THE INVENTION

1. Field of the Invention

The invention relates to a protecting circuit for a central processing unit (CPU) and, more particularly, to a protecting circuit for detecting whether the short is occurred.

2. Description of the Related Art

A CPU socket is used for connecting a CPU and a motherboard in a computer. A conventional CPU socket uses the pin grid array (PGA) structure, the pins at the CPU are needle in shape, and the pins of the CPU should be inserted into the socket accurately in assembling. Recently, a part of the CPUs and their sockets use the land grid array (LGA) structure, and the pins have an arc surface.

As the improvement of the calculating and accessing speed, the number of the CPU pins increases greatly. When the pins of the CPU forms too close, the CPU or the socket is easy to be burned due to the short between the pins of the CPU.

Since the CPU has many power pins, when the CPU is not inserted into the socket accurately, the power pin of the CPU is connected to the ground end and results in a short. However, if the force is not proper when placing the CPU, the pins of the CPU may also lean, the power pin of the CPU may be wrongly connected to the ground end to cause a short, or part of metal debris drop into the socket to occur a short. If the user boots the computer when the pins is occurred a short, the power supply provides the system voltage to the CPU socket, which results in the CPU socket burned down, or even the CPU burned down.

Conventionally, since the pins of the CPU are not too close, a mechanical fool-proof device is usually used when the CPU is placed into the CPU socket, or a instruction manual may be used to remind the user to be careful to avoid a misplacement. However, the technology of detecting whether the CPU is short or not is rare. Some protection technologies only detect whether the pins of the CPU are wrongly connected or connected to the ground end after the computer boots. However, if the pins of the CPU are already short before the booting, the conventional protection technology cannot prevent the CPU or the socket from being burned.

### BRIEF SUMMARY OF THE INVENTION

A protecting circuit for a CPU is provided. The protecting circuit stops providing a system power when a short is occurred between a power pin of the CPU and a ground end, to protect the CPU from being burned down or damaged.

A protecting circuit for a CPU is provided. The protecting circuit includes a detecting unit and an enable switch. The detecting unit detects whether a short is occurred between the power pin of the CPU and the ground end before the system voltage is provided to the power pin of the CPU. The enable switch is coupled to the detecting unit and determines whether to provide the system voltage to the power pin of the CPU according the detecting result of the detecting unit for preventing the system voltage from being provided to the CPU, and an electronic device of the CPU booting when the short is occurred between the power pin and the ground end.

In an embodiment of the invention, the detecting unit includes a standby power generating unit, a first resistor, a comparator and a register. The standby power generating unit outputs a standby power in a first predetermined period after the power supply provides a standby power to the power end. The first resistor is coupled between the standby power generating unit and the power pin. The comparator is coupled to the first resistor and compares a reference voltage and the pin voltage of the power pin to generate a comparing result. The register is coupled to the comparator and determines a potential of a booting enable signal after the first predetermined period according to the comparing result of the comparator, to prevent the system voltage from being provided to the CPU and prevent the electronic device from booting when the short is occurred between the power pin of the CPU and the ground end.

In the embodiment of the invention, the standby power generating unit includes a second resistor, a third resistor, a bipolar junction FET (BJT), an N-channel metal oxide semiconductor (NMOS) FET and a capacitor. The second resistor is coupled to the ground end. A collector of the BJT is coupled to the first resistor, an emitter of the BJT is coupled to the power end, and a base of the BJT is coupled to the second resistor. A drain of the NMOS FET is coupled to the power end; a source of the NMOS is coupled to the second resistor and the base of the BJT. The third resistor is coupled to a gate between the power end and the NMOS FET. The first capacitor is coupled to the third resistor and the ground end. The length of the first predetermined period is determined by the resistance of the third resistor and the capacitance of the first capacitor.

In the embodiment of the invention, the detecting unit further includes a reference voltage generating unit providing the reference voltage to the comparator in a second predetermined period after the power supply provides the standby power to the power end. The second predetermined period is shorter than the first predetermined period.

In the embodiment of the invention, the reference voltage generating unit includes a fourth resistor to a sixth resistor, a second capacitor and a NMOS FET. The fourth resistor is coupled to the power end. The second capacitor is coupled between the fourth resistor and the ground end. The drain of the NMOS FET is coupled to the comparator, the source of the NMOS is coupled to the ground end, and the gate of the NMOS is coupled between the fourth resistor and the second capacitor. The fifth resistor is coupled between the power end and the drain of the NMOS FET. The sixth resistor is coupled between the ground end and the drain of the NMOS FET. The length of the second predetermined period is determined by the resistance of the fourth resistor and the capacitance of the second capacitor.

In the embodiment of the invention, the register is a D flip-flop. A clock (CLK) input end of the D flip-flop is coupled to an output end of the comparator, a data input end of the D flip-flop is coupled to the power end, and a data output end of the D flip-flop outputs the booting enable signal.

In the embodiment of the invention, the enable switch includes a buffer. An input end of the buffer is coupled to a switch of the electronic device, and a control end of the buffer is coupled to the output end of the register to receive the booting enable signal. The output end of the buffer is coupled to an enable switch (P_{SON}) end of the power supply.

In the embodiment of the invention, the protecting circuit further includes an alerting unit executing an alerting action when the power pin of the CPU is connected to ground end.

As stated above, it detects whether the power pin of the CPU is connected to the ground end before booting. If a short is occurred, the power supply does not provide the system power to stop the booting of the electronic device with the CPU, and thus protect the CPU or the socket from being burned down.

These and other features, aspects and advantages of the present invention will become better understood with regard to the following description, appended claims, and accompanying drawings.

### BRIEF DESCRIPTION OF THE DRAWINGS

FIG. 1 is a block diagram showing an electronic device in an embodiment of the invention.

FIG. 2 is a functional diagram showing an electronic device in FIG. 1.

FIG. 3 is schematic diagram showing a detecting unit in an embodiment of the invention.

FIG. 4 is a schematic diagram showing a time sequence of a detecting unit in FIG. 3.

FIG. 5 is a circuit diagram showing a register in an embodiment of the invention.

FIG. 6 is a circuit diagram showing an enable switch in an embodiment of the invention.

FIG. 7 is a circuit diagram showing a standby power generating unit in an embodiment of the invention.

FIG. 8 is a circuit diagram showing a reference voltage generating unit in an embodiment of the invention.

### DETAILED DESCRIPTION OF THE EMBODIMENTS

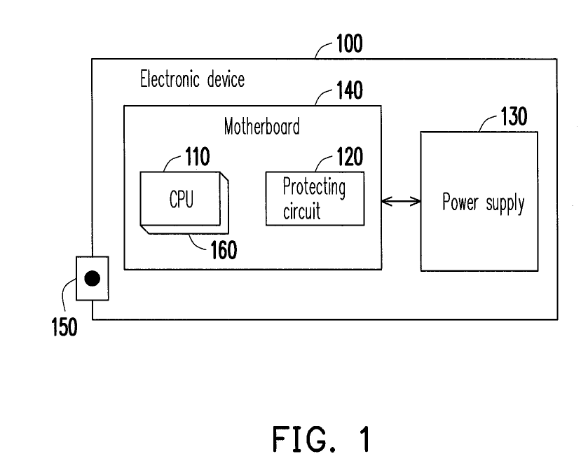

FIG. 1 is a block diagram showing the architecture of an electronic device 100 in an embodiment of the invention. The electronic device 100 includes a power supply 130 and a motherboard 140. The motherboard 140 includes a CPU 110 and a protecting circuit 120. The CPU 110 is disposed at a CPU socket 160. In the embodiment, when the user wants to boot the electronic device 100, he presses a switch 150 of the electronic device 100 to generate a booting signal S_{PSON}. The booting signal S_{PSON} also may be occurred in other ways such as using a network signal to boot the computer, which is not limited herein. The power supply 130 receives power supplied by AC power or a battery, and converts the received power to various voltages. When enable switch (P_{SON}) end of the power supply 130 receives the booting signal S_{PSON}, it converts the power to a system voltage, and provides the system voltage to the power pin of the CPU 110 via the CPU socket 160 at the motherboard 140 to boot the electronic device 100 and the CPU.

The power supply 130 provides a standby power (5V VSB) to the motherboard before the booting signal (S_{PSON}) is received (that is, before the electronic device 100 is booted). In the embodiment, the protecting circuit 120 at the motherboard is used for detecting whether the short is occurred between the power pin of the CPU 110 and the ground end before the electronic device 100 is booted and determining whether to prevent the booting signal (S_{PSON}) from being transmitted to the power supply 130 to prevent the system voltage from being provided to the CPU 110 to stop booting the electronic device 100. The standby power in the embodiment is a +5V standby voltage, which is not limited herein.

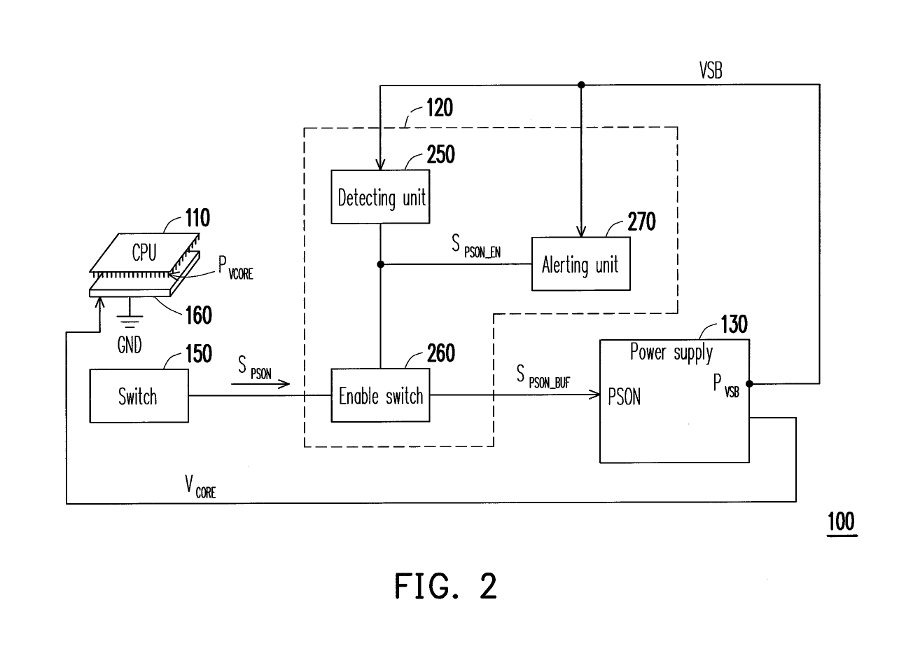

The theory and the operation flow of the protecting circuit 120 of the CPU 110 are illustrated hereinafter accompanying FIG. 2. FIG. 2 is a functional diagram showing the electronic device 100 in FIG. 1. The protecting circuit 120 of the CPU 110 includes a detecting unit 250, an alerting unit 270 and an enable switch 260. The detecting unit 250 detects whether the short is occurred between the power pin (P_{VCORE)} of the CPU 110 and the ground end before the system voltage (V_{CORE}) is provided to the CPU 110. In the embodiment, the detecting unit 250 generates a booting enabling signal (S_{PSON}_{_{—}}_{EN}) according to the detecting result. Moreover, the detecting unit 250 is coupled to the power pin (P_{VCORE}) of the CPU 110 via a CPU socket 160.

The enable switch 260 is coupled to the detecting unit 250, and determines whether to transmit the booting signal (SPSON) to the enable switch end (P_{SON)} of the power supply 130 according to the detecting result of the detecting unit 250 (that is, the received booting enabling signal (S_{PSON}_{_{—}}_{EN}) to determine whether the system voltage (V_{CORE}) is provided by the power supply 130 to the power pin (P_{VCORE}) of the CPU 110. As a result, the system voltage (V_{CORE)} would not be provided to the CPU 110 when the short is occurred between the power pin (PVOCRE) and the ground end, and thus it can prevent the electronic device 100 from booting. In the embodiment, when the booting enabling signal (S_{PSON}_{_{—}}_{EN}) is at a low level, the enable switch 260 is turned on. Thus, the potential of the booting buffering signal (S_{PSON}_{_{—}}_{BUF}) equals to that of the booting signal (S_{PSON}) and the booting signal (S_{PSON)} is transmitted to the enable switch (P_{SON)} end of the power supply 130. Correspondingly, when the booting enabling signal (S_{PSON}_{_{—EN}}) is at a high level, the enable switch 260 is turned off. Thus, the booting buffering signal (S_{PSON}_{_{—}}_{BUF}) stays at a power off potential (in the embodiment, when the enable switch (P_{SON}) is at a high level, the electronic device is power off, and when the enable switch (P_{SON}) is at the low level, the power supply 130 is triggered to boot the electronic device).

Besides, the protecting circuit 120 of the CPU 110 further includes an alerting unit 270 for executing an alerting action when the power pin (P_{VCORE}) of the CPU is connected to the ground end. The user can use the alerting unit and the alerting action according to different requirements. In the embodiment, the alerting unit 270 includes an alerting light. The alerting light lights to alert the user when the power pin (P_{VCORE}) is connected to the ground end. In other embodiments, the user may be alerted by sounds or other methods, which is not limited herein.

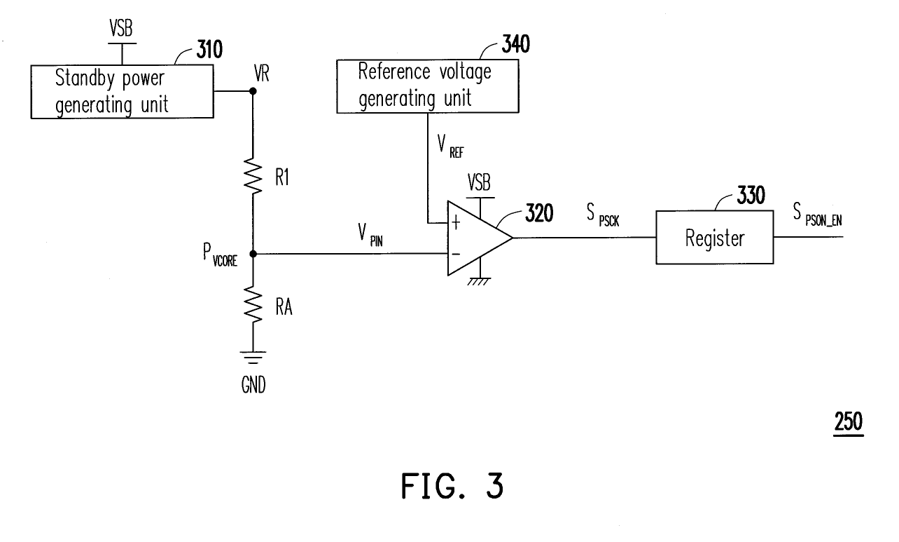

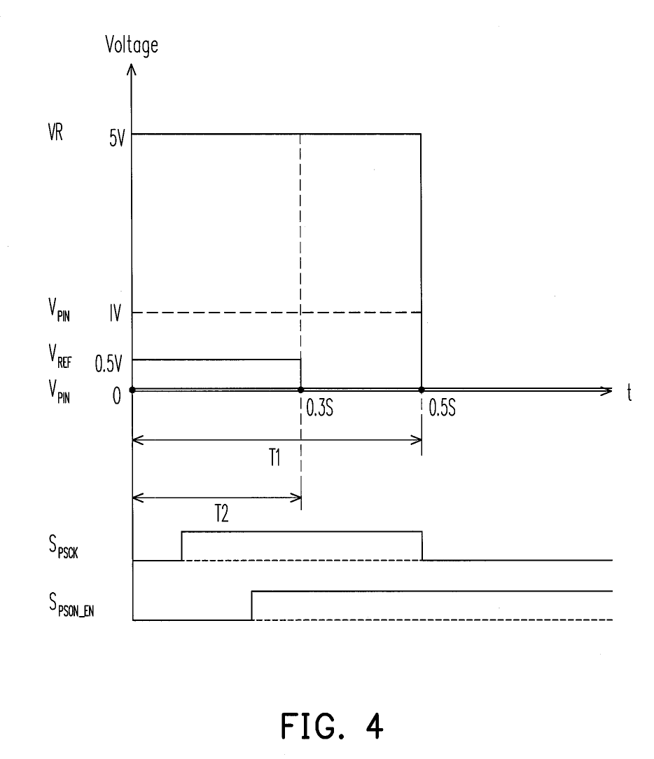

The function and operating theory of each component of the detecting unit 250 are illustrated in detail hereinafter. FIG. 3 is schematic diagram showing the detecting unit 250 in an embodiment of the invention. FIG. 4 is a schematic diagram showing a time sequence of the detecting unit 250 in FIG. 3. The detecting unit 250 includes a standby power generating unit 310, a first resistor R1, a comparator 320 and a register 330. The standby power generating unit 310 outputs a standby power (VR) in the first predetermined period (T1) after the power supply 130 provides the standby power (VSB) to the power end (P_{VSB}). The first resistor R1 is coupled between the standby power generating unit 310 and the power pin (P_{VCORE)}. An equivalent impedance (RA) is between the power pin (P_{VCORE}) of the CPU 110 and the ground end. A negative input end of the comparator 320 is coupled to the first resistor (R1), and a positive input end receives the reference voltage (V_{REF}). The power pin (P_{VCORE}) equals to the pin voltage (V_{PIN}) before it receives the system voltage (V_{CORE)}. According to the voltage divider theory, the pin voltage (V_{PIN}) equals to

$$( V R \times \frac{RA}{RA + R 1} ) .$$

The comparator 320 compares the reference voltage (V_{REF)} and the pin voltage (V_{PIN}) to generate a booting CLK signal (S_{PSCK)}.

The register 330 is coupled to the comparator 320 and determines the potential of the booting enable signal (S_{PSON}_{_{—}}_{EN}) after the first predetermined period T1 according to the comparing result of the comparator 320 (the booting CLK signal S_{PSCK}). The enable switch 260 receives the booting enable signal (S_{PSON}_{_{—}}_{EN}) to prevent the electronic device 100 from booting when the short is occurred between the power pin (P_{VCORE}) and the ground end. In the embodiment, the detecting unit 250 further includes a reference voltage generating unit 340 outputting the reference voltage (V_{REF}) to the comparator 320 in the second predetermined period (T2) after the power supply 130 provides the standby power (VSB) to the power end (P_{VSB}). The second predetermined period (T2) is shorter than the first predetermined period (T1).

The standby power generating unit 310 only outputs the standby power (VR) in the first predetermined period (T1) to avoid that the power pin (P_{VCORE}) of the CPU 110 is still coupled to the standby power generating unit 310 after the system voltage (V_{CORE}) is applied on the power pin (P_{VCORE}) to affect the operation of the CPU 110. Furthermore, since the pin voltage (V_{PIN}) is 0V after the first predetermined period T1, to avoid the reference voltage V_{REF} (0.5V) becomes larger than the pin voltage V_{PIN} (0V) after the first predetermined period T1, which makes the detecting unit 250 wrongly detect that the short is occurred between the CPU 110 and the ground end, the second predetermined period T2 is set to be shorter than the first predetermined period T1.

The acting theory of the detecting unit 250 is illustrated in detail accompanying FIG. 3 and FIG. 4. In the embodiment, the resistance of the first resistor R1 is assumed to be 160Ω, and the standby power generating unit 310 outputs a standby power (VR) 5V in the first predetermined period T1 (about 0.5 seconds). The reference voltage generating unit 340 provides the reference voltage V_{REF} 0.5V to the comparator 320 in the second predetermined period T2 (about 0.3 seconds). The start points of both the first predetermined period T1 and the second predetermined period are regarded as the time point that the power supply 130 provides the standby power (VSB) to the power end (P_{VSB)}, and in the embodiment, the time point is taken as the start point O.

At the start point O, when the CPU 110 is not inserted to the CPU socket 160, the equivalent impedance RA is infinite (∞). At the moment, it does not need to use the protecting circuit 120 to prevent the electronic device 100 from booting. When the CPU 110 is inserted to the CPU socket 160 correctly, the equivalent impedance RA is about 40Ω. Whereby, the pin voltage (V_{PIN}) is the divided voltage of the standby power (VR), and its value is about 1V in the first predetermined period (T1). The calculation is shown as the formula (1).

$${V}_{PIN} = V R \times \frac{RA}{RA + R 1} = 5 \times \frac{40}{40 + 160} = 5 \times \frac{40}{200} = 1 ( V ) \qquad ( 1 )$$

Since the pin voltage (V_{PIN})indicated by a dotted line in FIG. 4 is larger than the reference voltage(V_{REF)}, the comparator 320 keeps the booting CLK signal (S_{PSCK)} at the low level (0V) in the first predetermined period (T1) from the start point O (the voltage of the low level is 0V in the embodiment).

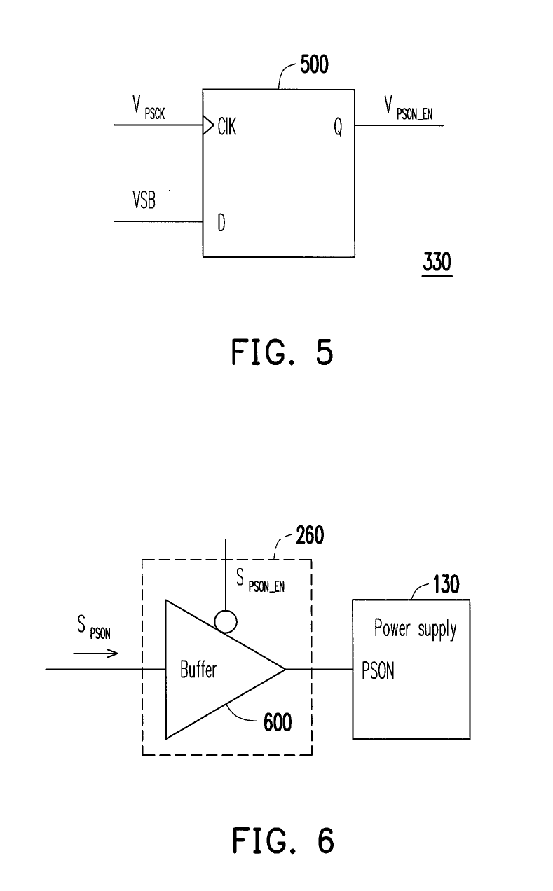

The register 330 is a positive going trigger D flip-flop 500 in the embodiment. FIG. 5 is a circuit diagram showing the register 330 in an embodiment of the invention. As shown in FIG. 4 and FIG. 5, a CLK input end CLK of the D flip-flop 500 is coupled to the output end of the comparator 320 to receive the booting CLK signal (S_{PSCK)}. The data input end D of the D flip-flop 500 is coupled to the power end (P_{VSB}) to receive the standby power (VSB), and the data output end Q outputs the booting enable signal (V_{PSON}_{_{—}}_{EN}). As a result, since the booting CLK signal (S_{PSCK}) stays at the low level (0V), the D flip-flop 500 is not triggered, and the potential of the booting enable signal (V_{PSON}_{_{—}}_{EN}) is at the low level (0V). At the time, the enable switch 260 is turned on (the enable switch 260 is turned on when the booting enable signal VPSON_EN is at the low level), and the voltage level of the booting buffering signal (S_{PSON}_{_{—}}_{BUF}) equals to that of the booting signal (S_{PSON)}, so as to transmit the booting signal (S_{PSON}) to the enable switch (P_{SON}) of the power supply 130.

When the short is occurred between the power pin (P_{VCORE}) of the CPU 110 and the ground end, for example, since the CPU 110 is inserted to the CPU socket 160 incorrectly, the impedance between the power pin (P_{VCORE}) and the ground end is 0Ω, and the pin voltage (V_{PIN}) is 0V. The pin voltage V_{PIN} (denoted by a solid line in FIG. 4) is smaller than the reference voltage (V_{REF)}, and the comparator 320 pulls the booting CLK signal (S_{PSCK}) from the low level to the high level in the first predetermined period (T1). The D flip-flop 500 of the register 330 receives the positive going triggering of the booting CLK signal (S_{PSCK}) to transmit the standby power VSB (5V in the embodiment) of the data input end D to the data output end Q, so as to determine that the potential of the booting enable signal (V_{PSON}_{_{—}}_{EN}) is at the high level (5V).

The enable switch 260 receives the booting enable signal (S_{PSON}_{_{—}}_{EN)}, and determines whether to transmit the booting signal (S_{PSON)} to the power supply 130 according to the booting enable signal (S_{PSON}_{_{—EN}}) to prevent booting the electronic device 100. FIG. 6 is a circuit diagram showing the enable switch 260 in an embodiment of the invention. The enable switch 260 in the embodiment includes a buffer 600, and the input end of the buffer 600 is coupled to the switch 150 of the electronic device 100 to receive the booting signal (S_{PSON)}. The control end of the buffer 600 is coupled to the detecting unit 250 to receive the booting enable signal (S_{PSON}_{_{—}}_{EN)}, and the output end is coupled to the enable switch (P_{PSON)} of the power supply 130.

In the embodiment, the buffer 600 is a low lever triggered (conducted) signal buffer. When the CPU 110 is inserted to the CPU socket 160 correctly, the booting enable signal (S_{PSON}_{_{—EN}}) is at the low level after the first predetermined period T1 (0V), and the buffer 600 conducts the output end and the input end due to the low level. Thus, the power supply 130 receives the booting signal (S_{PSON)}, the system voltage (V_{CORE)} is applied on the power pin (P_{VCORE)} after the first predetermined period T1, and the electronic device 100 is booted. Correspondingly, when the short is occurred between the power pin (P_{CORE}) of the CPU 110 and the ground end, the booting enable signal (S_{PSON}_{_{—}}_{EN}) is at the high level (5V) after the first predetermined period (T1). Thus, the buffer 600 is turned off, the booting signal (S_{PSON}) of the input end cannot be transmitted to the power supply 130, and the system voltage (V_{CORE}) is not provided to the power pin (PVCORE) of the CPU after the first predetermined period (T1) to prevent the electronic device 100 from booting.

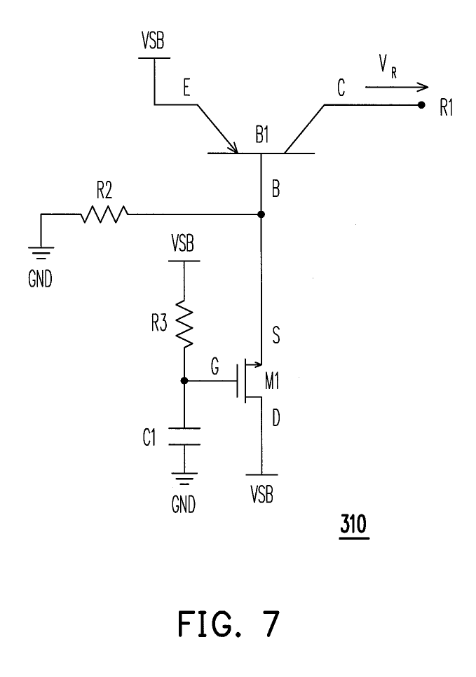

The circuit structure and the acting theory of the standby power generating unit 310 are illustrated in detail accompanying FIG. 7. FIG. 7 is a circuit diagram showing the standby power generating unit 310 in an embodiment of the invention. The standby power generating unit 310 includes a second resistor R2, a BJT B1, a first NMOS FET M1, a third resistor R3 and a first capacitor C1. The second resistor R2 is coupled between the ground end and a base B of the BJT B1. An emitter E of the BJT B1 is coupled to the power end P_{VSB} to receive the standby power (VSB), and a collector C is coupled to the first resistor R1 to output the standby power. A drain D of the first NMOS FET M1 is coupled to the power end (P_{VSB}) to receive the standby power (VSB), and a source S is coupled between the second resistor R2 and the base B of the BJT B1. The third resistor R3 is coupled between the power end (P_{VSB) and} the gate G of the first NMOS FET M1. The first capacitor C1 is coupled between the third resistor R3 and the ground end.

When the power supply 130 starts to provide the standby power (VSB) to the power end (P_{VSB}), since the first capacitor C1 does not store charges, the gate of the first NMOS FET M1 is at the low level to cut off the first NMOS FET M1. The base B of the BJT B1 is connected to the ground end via the second resistor R2, and thus the BJT B1 is turned on. As a result, the standby power (VSB) received by the emitter is transmitted to the collector of the BJT B1, and the standby power generating unit 310 outputs the standby power (the standby power VSB 5V) in the first predetermined period T1.

After the first predetermined period T1, the charges stored in the first capacitor C1 to make the gate of the first NMOS FET M1 at a high level, and thus the first NMOS FET M1 is turned on. The base B of the BJT B1 receives the standby power (VSB) via the first NMOS FET M1 to cut off the BJT B1. Thus, the standby power (VSB) of the emitter E cannot be transmitted to the collector C of the BJT B1 to make the standby power of the standby power generating unit 310 be 0V after the first predetermined period T1. The length of the first predetermined period T1 is determined by the resistance of the third resistor R3 and the capacitance of the first capacitor C1.

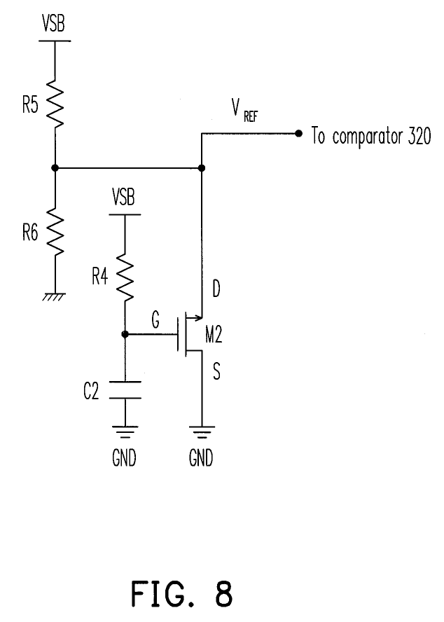

The circuit structure and the acting theory of the reference voltage generating unit 340 are illustrated in detail accompanying FIG. 8. FIG. 8 is a circuit diagram showing the reference voltage generating unit 340 in an embodiment of the invention. The reference voltage generating unit 340 includes a fourth resistor R4, a fifth resistor R5, a sixth resistor R6, a second capacitor C2 and a second NMOS FET M2. One end of the fourth resistor R4 is coupled to the power end (P_{VSB}) to receive the standby power (VSB), and the other end is coupled to the gate G of the second NMOS FET M2. One end of the second capacitor C2 is coupled between the fourth resistor R4 and the gate G of the second NMOS FET M2, and the other end is coupled to the ground end. The drain D of the second NMOS FET M2 is coupled to the comparator 320, and the source S is connected to the ground end. The fifth resistor R5 is coupled between the power end (P_{VSB}) and the drain D of the second NMOS FET M2 to receive the standby power (VSB), and the sixth resistor R6 is coupled to the ground end and the drain D of the second NMOS FET M2.

When the power supply 130 starts to provide the standby power (VSB) to the power end (P_{VSB}), since the second capacitor C2 does not store the charges, the gate G of the second NMOS FET M2 is at the low level, and thus the second NMOS FET M2 is cut off. Consequently, the reference voltage generating unit 340 divides the standby power (VSB) to the reference voltage V_{REF} via the fifth resistor R5 and the sixth resistor R6. In the embodiment, the reference voltage generating unit 340 provides the reference voltage V_{REF} 0.5V in the second predetermined period T2.

After the second predetermined period T2, the charges stored in the second capacitor C2 make the gate of the second NMOS FET M2 at the high level, and the drain and the source of the second NMOS FET M2 conduct. Thus, the reference voltage VR of the reference voltage generating unit 340 is 0V after the second predetermined period T2. The length of the second predetermined period T2 is determined by the resistance of the fourth resistor R4 and the capacitance of the second capacitor C2.

In sum, in the embodiment of the invention, whether the short is occurred between the power pin of the CPU and the ground end is detected before booting. When the short is occurred at the power pin, the enable switch is used to prevent the power supply from providing the system power. As a result, the electronic device with the CPU cannot he booted, and thus the CPU or the socket is protected from being burned down. Furthermore, in the embodiment of the invention, the alerting unit is added. When there is a short between the power pin of the CPU and the ground end, the alerting unit generates an alerting action to remind the user to remove the short of the CPU.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A protecting circuit for a central processing unit (CPU), comprising:
a detecting unit for detecting whether a short is occurred between a power pin of the CPU and a ground end before a system voltage is provided to the power pin to generate a detecting result; and
an enable switch coupled to the detecting unit and determining whether to provide the system voltage to the power pin according to the detecting result of the detecting unit;
when the detecting unit detects the short is occurred between the power pin of the CPU and the ground end, the enable switch is turned off to prevent the system voltage from being provided to the CPU.

2. The protecting circuit according to claim 1, wherein the detecting unit comprises:
a standby power generating unit for outputting a standby power in a first predetermined period after a power supply provides a standby power to a power end;
a first resistor coupled between the standby power generating unit and the power pin;
a comparator coupled to the first resistor and used for comparing a reference voltage and a pin voltage of the power pin to generate a comparing result; and
a register coupled to the comparator, determining a potential of a booting enable signal after the first predetermined period according to the comparing result of the comparator, and preventing the system voltage from being provided to the CPU when the short is occurred between the power pin of the CPU and the ground end.

3. The protecting circuit according to claim 2, wherein the standby power generating unit comprises:
a second resistor coupled to the ground end;
a bipolar junction FET (BJT), wherein a collector of the BJT is coupled to the first resistor, an emitter of the BJT is coupled to the power supply, and a base of the BJT is coupled to the second resistor;
an N-channel metal oxide semiconductor (NMOS) FET, wherein a drain of the NMOS is coupled to the power end, a source of the NMOS is coupled to the second resistor and the base of the BJT;
a third resistor coupled between the power end and a gate of the NMOS FET; and
a first capacitor coupled between the third resistor and the ground end;
wherein the length of the first predetermined period is determined by the resistance of the third resistor and the capacitance of the first capacitor.

4. The protecting circuit according to claim 2, wherein the detecting unit further comprises a reference voltage generating unit for providing the reference voltage to the comparator in a second predetermined period after the power supply provides the standby power to the power end, and the second predetermined period is shorter than the first predetermined period.

5. The protecting circuit according to claim 4, wherein the reference voltage generating unit comprises:
a fourth resistor coupled to the power end;
a second capacitor coupled between the fourth resistor and the ground end;
an NMOS FET, wherein a drain of the NOMS is coupled to the comparator, a source of the NOMS is coupled to the ground end, and a gate of the NOMS is coupled between the fourth resistor and the second capacitor;
a fifth resistor coupled between the power end and the drain of the NMOS PET; and
a sixth resistor coupled between the ground end and the drain of the NMOS FET;
wherein the length of the second predetermined period is determined by the resistance of the fourth resistor and the capacitance of the second capacitor.

6. The protecting circuit according to claim 2, wherein the register is a D flip-flop, a clock (CLK) input end of the D flip-flop is coupled to an output end of the comparator, a data input end of the D flip-flop is coupled to the power end, and a data output end of the D flip-flop outputs the booting enable signal.

7. The protecting circuit according to claim 2, wherein the enable switch comprises a buffer, an input end of the buffer is coupled to a switch of the electronic device, a control end of the buffer is coupled to an output end of the register to receive the booting enable signal, and an output end of the buffer is coupled to an enable switch of the power supply.

8. The protecting circuit according to claim 1, further comprising:
an alerting unit for executing an alerting action when the power pin of the CPU is connected to the ground end.
